(19) United States
(12) Patent Application Publication
(10) Pub. No.: US 2015/0092267 A1
(43) Pub. Date: Apr. 2, 2015

(54) AUTOSTEREOSCOPIC 3D IMAGE DISPLAY APPARATUS USING MICRO LENS ARRAY

(71) Applicant: Electronics and Telecommunications Research Institute, Daejeon (KR)

(72) Inventors: Bong-Je PARK, Daejeon (KR); Ki-Uk KYUNG, Seoul (KR); Sung-Ryul YUN, Daejeon (KR); Sun-Tak PARK, Daejeon (KR)

(73) Assignee: Electronics and Telecommunications Research Institute, Daejeon (KR)

(21) Appl. No.: 14/201,102

(22) Filed: Mar. 7, 2014

(30) Foreign Application Priority Data
Sep. 30, 2013 (KR) 10-2013-0116156

(51) Int. Cl. G02B 27/22

(52) U.S. Cl. CPC G02B 27/2214
USPC 359/463

(57) ABSTRACT

An autostereoscopic 3D image display apparatus is disclosed. The autostereoscopic 3D image display apparatus in accordance with an embodiment of the present invention can include: an image display unit configured to display an image; a micro lens array arranged above the image display unit and configured to vary a focus of an image from the image display unit; and an electrode coated on the micro lens array and configured to have an electric signal supplied thereto to cause transformation of the micro lens array.

### CROSS-REFERENCE TO RELATED APPLICATIONS

This application claims the benefit of Korean Patent Application No. 10-2013-0116156, filed with the Korean Intellectual Property Office on Sep. 30, 2013, the disclosure of which is incorporated herein by reference in its entirety.

### BACKGROUND

1. Technical Field

The present invention relates to a 3D image display apparatus, mores specifically to an autostereoscopic 3D image display apparatus.

2. Background Art

While there are many ways to realize a 3D image, they are mainly divided into two groups, depending on whether glasses are worn or not. The methods requiring the glasses (i.e., stereoscopic) are single-view methods and thus cannot realize motion parallax. Accordingly, same images are projected regardless of the positions of the viewers' eyes, and thus the same image is shown to a viewer even if the viewer changes the position, failing to provide the realistic and animated senses. Moreover, the requirement of having to wear the glasses is ever inconvenient for the viewers.

On the other hand, in the case of the glassless methods (i.e., autostereoscopic), used for realizing the 3D images are multi-view methods, mostly the parallax barrier method and the lenticular lens method.

The parallax barrier method was first introduced by F. E. Ives in 1903 in the U.S. In this method, the 3D image is realized by blocking opposite images of either eye, according to the angle of view, by use of a barrier in which a series of slits are arranged in order to provide parallax. Furthermore, a switchable 2D/3D device can be realized by electrically turning on/off the barrier by use of a switchable parallax barrier using liquid crystal technology. However, said parallax barrier method has the shortcoming of low luminance of 3D images because a significant amount of light is blocked due to the barrier between the display and a user. Moreover, since the left and right images are separated when the user is at a specific distance from the screen, the 3D images are not visible if the user is outside the specified location.

Although H. E. Ives obtained patent for the lenticular lens method in 1932, it was only in the 1960s when the lenticular lens method began to see some technological advancement. In the lenticular lens method, lenticular lenses are arranged on a display, and a left image and a right image are separately viewed by left and right eyes, respectively, using the refractive characteristics of the lenticular lenses. In the beginning, it was only possible to display 3D images, but it has become possible to covert between 2D and 3D images using double refraction characteristics of liquid crystal. That is, a 2D image is provided if the refractive indexes between an inside and an outside of the liquid crystal are the same because the liquid crystal cannot function as a lens, and a 3D image is provided if the refractive indexes between the inside and the outside of the liquid crystal are different. The lenticular lens method does not suffer with the luminance drop as the parallax barrier method but has a shortcoming of deteriorated 2D or 3D picture quality if the refractive indexes are not precisely controlled.

### SUMMARY

The present invention provides an autostereoscopic 3D image display apparatus using micro lens array that can provide a 3D image without losing luminance.

The present invention also provides an autostereoscopic 3D image display apparatus using micro lens array that can be easily handled and manufactured.

The present invention also provides an autostereoscopic 3D image display apparatus using micro lens array that can adjust a focus of an image displayed by an image display unit.

The autostereoscopic 3D image display apparatus in accordance with an embodiment of the present invention can include: an image display unit configured to display an image; a micro lens array arranged above the image display unit and configured to vary a focus of an image from the image display unit; and an electrode coated on the micro lens array and configured to have an electric signal supplied thereto to cause transformation of the micro lens array.

The micro lens array can be made of a polymer material.

The micro lens array can be made of electroactive polymer material.

The electrode can be a transparent electrode.

The electrode can be coated on each of lenses constituting the micro lens array.

The electrode coated on each of the lenses can include an upper electrode coated in an upper portion of the lens and a lower electrode coated in a lower portion of the lens.

The upper electrode can be coated entirely on the upper portion of the lens.

The upper electrode can be partially coated on the upper portion of the lens.

The upper electrode coated partially on the upper portion of the lens can cause the lens to be locally transformed by having the electric signal supplied locally thereto.

### BRIEF DESCRIPTION OF THE DRAWINGS

FIG. 1 shows a 3D image display apparatus in accordance with an embodiment of the present invention.

FIGS. 2a and 2b show a cross-sectional view and operation of the 3D image display apparatus in accordance with an embodiment of the present invention.

FIGS. 3a and 3b show a cross-sectional view and operation of a 3D image display apparatus in accordance with another embodiment of the present invention.

FIG. 4 shows how a 3D image is formed by the 3D image display apparatus described through FIGS. 3a and 3b.

### DETAILED DESCRIPTION

Hereinafter, certain embodiments of the present invention will be described in detail with reference to the accompanying drawings. Any substantially identical elements in the description below and accompanying drawings will be assigned with same reference numerals and will not be redundantly described. Moreover, whenever it is deemed that providing detailed description of any relevant known function or element will inadvertently evade the gist of the present invention, such description will be omitted.

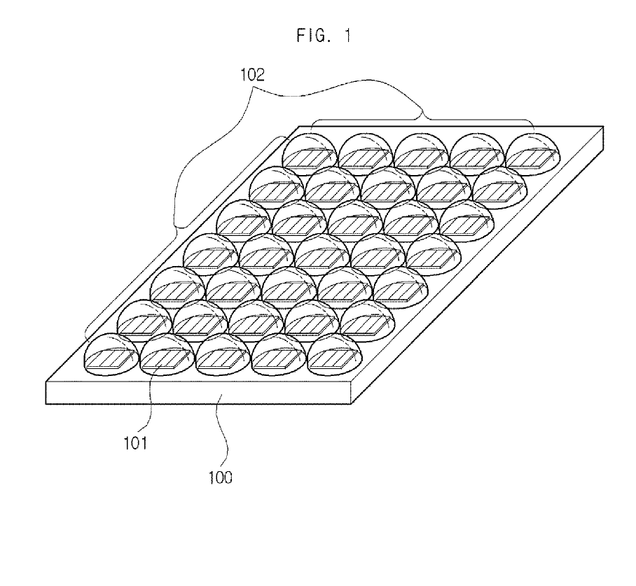

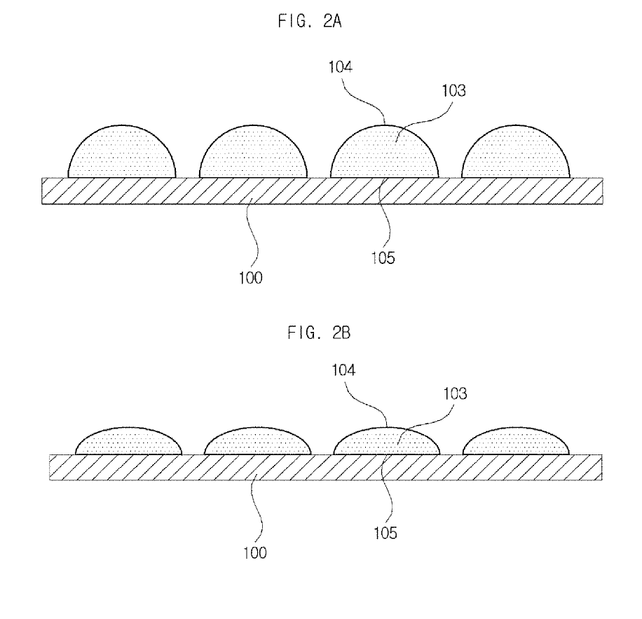

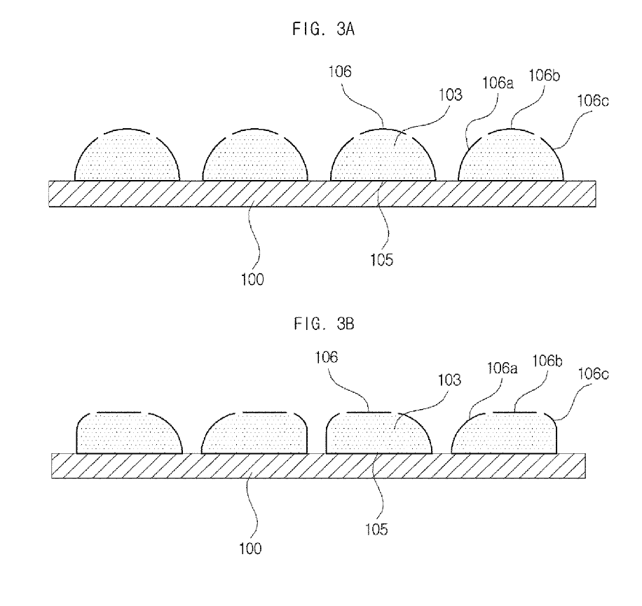

FIG. 1 shows a 3D image display apparatus in accordance with an embodiment of the present invention. As illustrated in FIG. 1, the 3D image display apparatus in accordance with the present embodiment includes an image display apparatus 100, a micro lens array 102, which is arranged above the image display unit 100 and configured to change a focus of an image displayed by the image display unit 100, and, although now shown, an electrode coated on the micro lens array 102. The electrode will be described later with reference to FIGS. 2a to 3b.

The image display unit 100 is configured to display an image using a plurality of pixels 101 and can be, but not limited to, LCD (Liquid Crystal Display), PDP (Plasma Display Panel), OLED (Organic Light Emitting Diode), or AMOLED (Active Matrix Organic Light Emitting Diode). A back-light unit is commonly provided in the back of the image display unit 100. Depending on the perspective, the back-light unit can be considered as part of the image display unit 100.

Micro lens array 102, which is an array of plural lenses, as illustrated, can be arranged above the image display unit 100 to change a focus of an image displayed by the image display unit 100. Each of the lenses constituting the micro lens array 102 can be arranged in each pixel of the image display unit 100, as illustrated in FIG. 1. Referring to FIG. 1, one lens corresponds to one pixel, it is also possible that one lens corresponds to two or more pixels, depending on the size of the lens.

The lenses constituting the micro lens array 102 are a morphing lens that can be transformed according to an applied electrical signal. Accordingly, once an electrical signal is supplied to the electrode coated on the micro lens array 102, the micro lens array 105 is transformed, and the focus of the image displayed by the image display unit 100 is changed. The electrode coated on the micro lens array 102 can be constituted with an upper electrode, which is coated in an upper portion, and a lower electrode, which is coated in a lower portion, and it is preferable that the upper electrode and the lower electrode are transparent electrodes. Then, an image generated by the image display unit 100 passes through the transparent lower electrode in the lower portion of the micro lens array 102 and then the micro lens array 102 and the transparent upper electrode in the upper portion of the micro lens array 102, and then reaches the eyes of a user. As described herein, since the image passes through the transparent micro lens array 102 and the transparent upper electrode and lower electrode coated thereon, a clear quality of image can be provided with the brightness of image that is not more deteriorated than the conventional parallax barrier method or lenticular lens method.

The micro lens array 102 can be made of polymer material that can be transformed when electricity is supplied. Used for a typical polymer material in an embodiment of the present invention can be, but not limited to, an electroactive polymer material, such as PDMS (polydimethylsiloxane). When electricity is supplied, the electroactive polymer material is transformed according to the quantity of electricity. The transformable micro lens array can be made using this property. For instance, in case the electrode is coated on the entire lens, the lens is entirely transformed when electricity is supplied. Accordingly, it becomes possible to realize a variable focus lens, which varies the focal distance of the lens only. This will be further described with reference to FIGS. 2a and 2b. In another example, in case the electrode is partially coated on the lens, only a part of the lens can be transformed, or the lens can be transformed differently at different portions thereof, when electricity is supplied to the electrode locally. Accordingly, it becomes possible not only to vary the focal distance of the lens but also to change the direction of the focus, and thus it becomes possible to realize a multi-view lens and provide a 3D image using the multi-view lens. This will be described further with reference to FIGS. 3a and 3b.

Since the upper electrode coated on the micro lens array 102 needs to be coated on a curved portion, the upper electrode can be generated using, for example, spray coating. On the other hand, since the lower electrode coated on the micro lens array 102 is coated on a flat portion, the lower electrode can be generated using, for example, spray coating or silk screen printing. Used for the upper electrode and the lower electrode can be transparent electrode, such as silver (Ag) nano wire or graphene, of which the shape is not broken or the properties are not changed despite the transformation of the lens.

FIGS. 2a and 2b show a cross-sectional view and operation of the 3D image display apparatus in accordance with an embodiment of the present invention, and the electrode is coated on the entire lens in the present embodiment. In the present embodiment, each of lenses 103 forming the micro lens array 102 is made of a transparent and flexible electroactive polymer material, and the electrode is constituted with an upper transparent electrode 104, which is coated entirely on an upper portion of the lens 103, and a lower transparent electrode 105, which is coated on a lower portion of the lens 103. FIG. 2a shows a state when electricity is not supplied to the electrodes 104, 105, and FIG. 2b shows a state when electricity is supplied to the electrodes 104, 105. As illustrated in FIGS. 2a and 2b, transformation is occurred in the electroactive polymer material by the electricity when the electricity is supplied to the electrodes 104, 105, and the lens 103 is entirely contracted compared to when the electricity is not supplied. As a result, the focal distance of the lens 103 is changed. Accordingly, the lens 103 can be used as a variable focus lens, which can adjust the focal distance. However, since it is not possible to adjust the direction of focus, the lens 103 cannot be used as a multi-view lens.

FIGS. 3a and 3b show a cross-sectional view and operation of a 3D image display apparatus in accordance with another embodiment of the present invention, and an electrode is partially coated on a lens to allow electricity to be supplied locally to the lens in the present embodiment. In the present embodiment, each of lenses 103 forming the micro lens array 102 is made of a transparent and flexible electroactive polymer material, and the electrode is constituted with an upper transparent electrode 106, which is coated partially on an upper portion of the lens 103, and a lower transparent electrode 105, which is coated on a lower portion of the lens 103. The upper transparent electrode 106 is constituted with electrodes 106a, 106b, 106c that are partially coated on the upper portion of the lens 103. FIG. 3a shows a state when electricity is not supplied to the electrodes 105, 106, and FIG. 3b shows a state when electricity is supplied to the electrodes 105, 106. By supplying the electricity to some of the electrodes 106a, 106b, 106c or by varying the quantity of electricity supplied to the electrodes 106a, 106b, 106c, the shape of the lens 105 can be asymmetrically transformed, as illustrated in FIG. 3b. According to the present embodiment, the shape of the lens can be variably transformed by varying the quantity of electricity that is supplied locally. By variably transforming the shape of the lens, the micro lens array 102 can be used as a multi-view lens that can provide a 3D image.

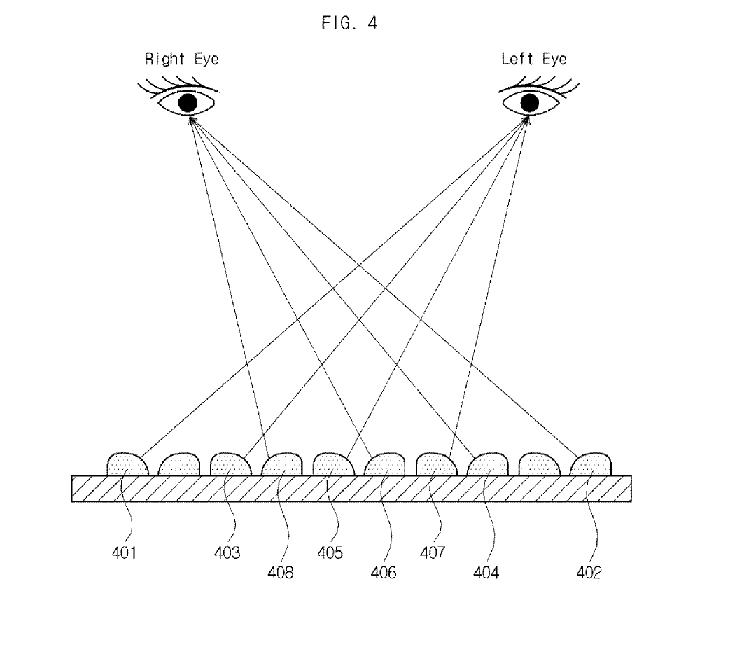

FIG. 4 shows how a 3D image is formed by the 3D image display apparatus described through FIGS. 3a and 3b. Referring to FIG. 4, by supplying electricity differently for different lenses that constitute the micro lens array 102, a desired focal point can be formed for each lens, and a beam from each pixel (or from each portion) of the image display unit 100 can be directed to a desired point. For example, the shape of lenses can be transformed in such a way that the beams from the pixels corresponding to the lenses 401, 403, 405, 407 can be made to reach a left eye of a viewer and the beams from the pixels corresponding to the lenses 402, 404, 406, 408 can be made to reach a right eye of the viewer. Accordingly, a 3D image is provided by realizing a left-eye image with the pixels corresponding to the lenses 401, 403, 405, 407 and realizing a right-eye image with the pixels corresponding to the lenses 402, 404, 406, 408. Moreover, according to the present embodiment, the lenses constituting the micro lens array 102 can have their focal points adjusted individually, and thus a sharp 3D image can be provided by adjusting the focal point of each lens according to the position of the viewer even if the viewer's position is changed. While in the case of the conventional parallax barrier method or lenticular lens method, the 3D image has become inevitably dull if the viewer's position is changed, the present embodiment is capable of overcoming such a shortcoming

Moreover, according to a certain embodiment of the present embodiment, the lenses constituting the micro lens array 102 go back to their original shapes if the electricity is no longer supplied to the electrode coated on the micro lens array 102, and thus it is possible to selectively provide a 2D image or a 3D image by supplying or not supplying the electricity.

Furthermore, since the micro lens array and the electrode are made of flexible material, it is possible to provide a flexible 3D image display apparatus.

Although certain embodiments of the present invention have been described, it shall be appreciated that there can be a very large number of permutations and modification of the present invention by those who are ordinarily skilled in the art to which the present invention pertains without departing from the technical ideas and boundaries of the present invention, which shall be defined by the claims appended below.

It shall be also appreciated that many other embodiments other than the embodiments described above are included in the claims of the present invention.

What is claimed is:

1. An autostereoscopic 3D image display apparatus, comprising:
an image display unit configured to display an image;
a micro lens array arranged above the image display unit and configured to vary a focus of an image from the image display unit; and
an electrode coated on the micro lens array and configured to have an electric signal supplied thereto to cause transformation of the micro lens array.

2. The autostereoscopic 3D image display apparatus of claim 1, wherein the micro lens array is made of a polymer material.

3. The autostereoscopic 3D image display apparatus of claim 1, wherein the micro lens array is made of electroactive polymer material.

4. The autostereoscopic 3D image display apparatus of claim 1, wherein the electrode is a transparent electrode.

5. The autostereoscopic 3D image display apparatus of claim 1, wherein the electrode is coated on each of lenses constituting the micro lens array.

6. The autostereoscopic 3D image display apparatus of claim 5, wherein the electrode coated on each of the lenses comprises an upper electrode coated in an upper portion of the lens and a lower electrode coated in a lower portion of the lens.

7. The autostereoscopic 3D image display apparatus of claim 6, wherein the upper electrode is coated entirely on the upper portion of the lens.

8. The autostereoscopic 3D image display apparatus of claim 6, wherein the upper electrode is partially coated on the upper portion of the lens.

9. The autostereoscopic 3D image display apparatus of claim 8, wherein the upper electrode coated partially on the upper portion of the lens causes the lens to be locally transformed by having the electric signal supplied locally thereto.
